(19) United States
(12) Patent Application Publication
(10) Pub. No.: US 2009/0146042 A1
(43) Pub. Date: Jun. 11, 2009

(54) MOLD COMPRISING A PTC-CERAMIC

(76) Inventors: Jan Ihle, Deutschlandsberg (AT); Werner Kahr, Deutschlandsberg (AT); Markus Rath, Deutschlandsberg (AT)

Correspondence Address: FISH & RICHARDSON PC, P.O. BOX 1022, MINNEAPOLIS, MN, 55440-1022, US

(21) Appl. No.: 11/950,669

(22) Filed: Dec. 5, 2007

(51) Int. Cl. B28B 7/42; B28B 7/00; B28B 7/34

(52) U.S. Cl. 249/78

(57) ABSTRACT

A mold includes a fluid channel, a fluid inlet, and a fluid outlet. The mold is manufactured, at least in part, from a PTC-ceramic material. Upon application of a voltage to the mold, the mold is heated such that a fluid passing through the fluid channel may also be subject to heating.

### CROSS-REFERENCE TO RELATED APPLICATIONS

The following patent applications, all of which were filed on the same day as this patent application, are hereby incorporated by reference into this patent application as if set forth herein in full: (1) U.S. patent application Ser. No. ______, entitled “Injection Molded PTC-Ceramics”, Attorney Docket No. 14219-186001, Application Ref. P2007,1179USE; (2) U.S. patent application Ser. No. ______, entitled “Feedstock And Method For Preparing The Feedstock”, Attorney Docket No. 14219-187001, Application Ref. P2007,1180USE; (3) U.S. patent application Ser. No. ______, entitled “Process For Heating A Fluid And An Injection Molded Molding”, Attorney Docket No. 14219-182001, Application Ref. P2007,1182USE; (4) U.S. patent application Ser. No. ______, entitled “Injection Molded Nozzle And Injector And Injector Comprising The Injection Molded Nozzle”, Attorney Docket No. 14219-183001, Application Ref. P2007,1183USE; and (5) U.S. patent application Ser. No. ______, entitled “PTC-Resistor”, Attorney Docket No. 14219-185001, Application Ref. P2007,1184USE.

### TECHNICAL FIELD

This disclosure relates to fuel injector systems for combustion engines, in particular to heaters for fuels.

### BACKGROUND

There is a need for providing fuel at an appropriate temperature in an engine that is still cold. This problem occurs especially when the fuel contains methanol or ethanol as a main component. In this case, may be difficult to spray the fuel in an appropriate way when the outer temperatures are low and the engine is not located in a heated housing such as the engine of an automobile. If the fuel is not at the minimum temperature and the spray of the fuel is not sufficiently fine, the result is an insufficient mixing of fuel and air in the combustion chamber.

### SUMMARY

A heating system for fluids in the form of a mold comprising a ceramic with a positive temperature coefficient, a so called PTC-ceramic, is described. The ceramic may for example be based on Bariumtitanate (BaTiO₃), which is a ceramic of the perovskite-type (ABO₃). The ceramic can be doped for example in the view of the Curie-temperature T_{C}, which for example can be chosen on her part in view of the boiling point of the liquid, which should be heated. A doping of the BaTiO₃ ceramic with Sr decreases the Curie-temperature, whereas a doping with Pb increases the Curie-temperature. Additionally TiO₂ and SiO₂ can be added to the ceramic.

The heating system can be injection molded out of the PTC-ceramic. A fluid to be heated is heated via the heating system as it flows through the mold. The heating system may be located next to a nozzle that ejects it.

By preheating a fuel before it reaches a nozzle, a finer quality of spray ejected from the nozzle is obtainable. In view of this, the temperature may be controlled in consideration of the boiling point of the fuel or its spraying temperature. The PTC-ceramic and the voltage applied to the mold may be chosen under this aspect.

The PTC-ceramic comprises a self regulative property. If the temperature of the heating system reaches a critical level, the resistance of the PTC ceramic also rises and thus reduces the electric current running through it. As a result, the PTC ceramic of the mold ceases to heat and is allowed to cool. Thus, no external regulation system is necessary if the PTC-ceramic material is chosen under the view of the fluid respectively to the temperature, which the fluid should reach maximum. This also means that the system regulates itself back, when heat additionally comes from the engine such as when it has been running for a while.

The heating system responds rapidly for two main reasons: firstly, it warms quickly and secondly, the heat is rapidly transferable to the fluid due to the latter's direct contact with the mold. The direct contact with the mold enables a fast and efficient transfer of the energy to the fluid compared to systems where a heating system is located around a channel or a tube in which the fluid is running.

In order to increase the rate of heat transfer, the inner surface of the mold may be enlarged by providing it with geometric moldings.

To achieve a high degree heat transfer between the molding an a fluid passing through the fluid channel, the fluid may flow at a moderate speed in at least one part of the heating system. The cross section of the fluid channel therefore may vary. A larger cross section on the inlet side and a smaller cross section at the outlet side of the fluid channel makes it possible to have a slower flow rate of the fluid in a first part of the mold in order to obtain a high degree of heat transfer a higher flow rate at the end of the heating system. The latter may be preferable for a spraying process. It thus may be preferred to reduce the cross section of the fluid channel in at least one subsection of the mold. Shapes and forms conducive to this goal are obtainable by injection molding.

For the injection molding process a feedstock could be used comprising a ceramic filler, a matrix for binding the filler and a content of less than 10 ppm of metallic impurities. One possible ceramic filler can be denoted by the structure:

Ba_{1-x-y}MₓD_{y}Ti_{1-a-b}NₐMn_{b}O₃

wherein the parameters are x=0 to 0.5, y=0 to 0.01, a=0 to 0.01 and b=0 to 0.01. In this structure M stands for a cation of the valency two, like for example Ca, Sr or Pb, D stands for a donor of the valency three or four, for example Y, La or rare earth elements, and N stands for a cation of the valency five or six, for example Nb or Sb. Thus, a high variety of ceramic materials can be used wherein the composition of the ceramic may be chosen in dependency of the required electrical features of the later sintered ceramic. The ceramic filler of the feedstock is convertible to a PTC-ceramic with low resistivity and a steep slope of the resistance-temperature curve. The resistivity of a PTC-ceramic made of such a feedstock can comprise a range from 3 Ωcm to 30000 Ωcm at 25° C. in dependence of the composition of the ceramic filler and the conditions during sintering the feedstock. The characteristic temperature T_{b} at which the resistance begins to increase comprises a range of −30° C. to 340° C. As higher amounts of impurities could impede the electrical features of the molded PTC-ceramic the content of the metallic impurities in the feedstock is lower than 10 ppm.

The metallic impurities in the feedstock may comprise Fe, Al, Ni, Cr and W. Their content in the feedstock, in combination with one another or each respectively, is less than 10 ppm due to abrasion from tools employed during the preparation of the feedstock.

A method for preparing a feedstock for injection molding is described, comprising the steps A) preparing a ceramic filler being convertible to PTC-ceramic by sintering, B) mixing the ceramic filler with a matrix for binding the filler, and C) producing a granulate comprising the filler and the matrix.

The method comprises using tools having such a low degree of abrasion that a feedstock comprising less than 10 ppm of impurities caused by said abrasion is prepared. Thus, preparation of injection moldable feedstocks with a low amount of abrasion caused metallic impurities is achieved without the loss of desired electrical features of the molded PTC-ceramic.

In step A) base materials of the filler can be mixed, calcinated and ground to a powder. During the calcination which can be performed at temperatures of about 1100° C. for around two hours a ceramic material of the structure Ba_{1-x-y}MₓD_{y}Ti_{1-a-b}NₐMn_{b}O₃ with x=0 to 0.5, y=0 to 0.01, a=0 to 0.01 and b=0 to 0.01 is formed, where M stand for a cation of the valency two, D a donor of the valency three or four, for example Y, La or rare earth elements, and N a cation of the valency five or six, for example Nb or Sb. This ceramic material is ground to a powder and dried to obtain the ceramic filler.

As base materials, BaCO₃, TiO₂, Mn- and Y-ion containing solutions and at least one out of the group of SiO₂, CaCO₃, SrCO₃, Pb₃O₄ may be used to prepare the ceramic filler. From these base materials a ceramic material of a composition such as (Ba_{0.3290}Ca_{0.0505}Sr_{0.0969}Pb_{0.1306}Y_{0.005}) (Ti_{0.502}Mn_{0.0007})O_{1.5045} can be prepared, for example. A sintered body of this ceramic material has a characteristic reference temperature T_{b} of 122° C. and—depending on the conditions during sintering—a resistivity range from 40 to 200 Ωcm.

According to an implementation of the method, step B) is performed at a temperature of 100° C. to 200° C. First, the ceramic filler and the matrix are mixed at room temperature, after which this cold mixture is put into a hot mixer which is heated to temperatures of 100° C. to 200° C., e.g., between 120° C. to 170° C., for example 1600C. The ceramic filler and the matrix which binds the filler are kneaded in the hot mixer to homogenous consistency at elevated temperatures. As a mixer or mixing device, a twin-roll mill or other kneading/crushing device may be used.

A twin-roll mill may include two counter-rotating differential speed rollers with an adjustable nip and imposes intense shear stresses on the ceramic filler and the matrix as they pass through the nip. Further, a single-screw or a twin-screw extruder as well as a ball mill or a blade-type mixer may be used for preparing the mixture containing the matrix and the ceramic filler.

In step C), the mixture of matrix and ceramic filler can be cooled to room temperature and reduced to small pieces. The mixture hardens when it is cooled and by reducing it to small pieces a granulate of feedstock material is formed.

According to an implementation of the method, the tools used in method steps A), B) and C) comprise coatings of a hard material. The coating may comprise any hard metal, such as, for example, tungsten carbide (WC). Such a coating reduces the degree of abrasion of the tools when in contact with the mixture of ceramic filler and matrix and enables the preparation of a feedstock with a low amount of metallic impurities caused by said abrasion. Metallic impurities may be Fe, but also Al, Ni or Cr. When the tools are coated with a hard coating such as WC, impurities of W may be introduced into the feedstock. However, these impurities have a content of less than 50 ppm. It was found that in this concentration, they do not influence the desired electrical features of the sintered PTC-ceramic.

Where injection molding is used to form the mold, care must be taken regarding the metallic impurities in the mold to ensure that the efficiency of the PTC-ceramic is not reduced. The PTC-effect of ceramic materials comprises a change of the electric resistivity ρ as a function of the temperature T. While in a certain temperature range the change of the resistivity ρ is small with a rise of the temperature T, starting at the so-called Curie-temperature T_{C} the resistivity ρ rapidly increases with a rise of temperature. In this second temperature range, the temperature coefficient, which is the relative change of the resistivity at a given temperature, can be in a range of 50%/K up to 100%/K. If there is no rapidly increase at the Curie-temperature the self regulating property of the mold is unsatisfactory.

In order to obtain a desirable efficiency of the mold, the entire mold may be suited to transferring heat to the fluid. Thus, an electric current may flow through the entire or nearly the entire mass of the mold. Therefore, the entire or nearly the entire surface of the inner and outer side of the mold is provided with electrical contacts. According to one embodiment of the mold, it is provided with electrically conductive layers on its inner an outer surface.

The inner side of the mold additionally comprises, according to one embodiment, a passivation layer to prevent interactions, such as chemical reactions, between the fluid and the PTC-ceramic or the electric contact layer.

### BRIEF DESCRIPTION OF THE DRAWINGS

A number of embodiments are shown in the following drawings. The illustrations of the embodiments are schematic.

FIG. 1 shows a section of an embodiment of a mold comprising a PTC ceramic,

FIGS. 2a to 2c show a preheating process of a liquid in an embodiment according to FIG. 1,

FIG. 3 shows an embodiment with a non-cylindrical form and more than one fluid outlet,

FIG. 4 shows a schematic view inside a embodiment with a plurality of fluid channels.

### DETAILED DESCRIPTION

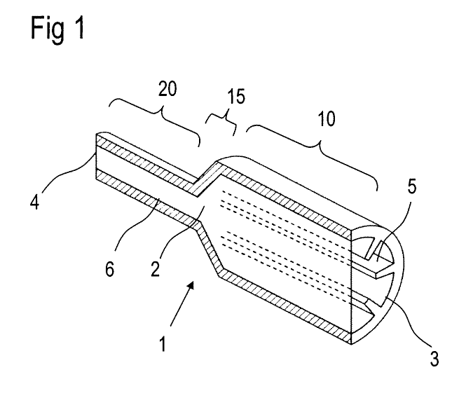

FIG. 1 depicts a mold 1 with a fluid channel 2, a fluid inlet 3 and a fluid outlet 4. The mold can be subdivided into three subsections: a first subsection 10 at the fluid inlet 3, a second subsection 20 at the fluid outlet 4, and one subsection 15 between the first and the second. In this embodiment the cross section of the first subsection 10 is larger than the cross section of the second subsection 20 and the fluid inlet 3 is larger than the fluid outlet 4. So the speed of a fluid flowing through the fluid channel 2 is lower in the first subsection, thereby improving heat transfer from the mold to the fluid.

The inner surface of the first subsection 10 is enlarged by geometric protrusions 5. In this embodiment the geometric protrusions 5 are molded as ribs. The larger inner surface of the mold 1 makes the heating system more efficient, since the heat can be transferred more rapidly from the mold to the fluid flowing through it. The ribs can be helical such that the fluid flowing through the fluid channel 2 is made to rotate around the axis of the flow.

The mold 1 is injection molded from a PTC-ceramic with the following composition: ABO₃+SiO₂, whereby A is composed of Ba 83.54 mol %, Ca 13.5 mol %, Sr 2.5 mol %, Y 0.4 mol % and B is composed of Ti 99.94 mol %, Mn 0.06 mol %. The part of Si is 2 mol % relating to the sum of both components. This composition can for example be used for a preheating system for ethanol. The concentration of any metallic impurity is lower than 10 ppm.

The mold 1 is provided with an electrically conductive layer on its inner and outer surface. The inner surface is additionally provided with a passivation layer 6. This passivation layer 6 can for example comprise low melting glass or nano-composite lacquer. The nano-composite lacquer can comprise one or more of the following composites: SiO₂-polyacrylate-composite, SiO₂-polyether-composite, SiO₂-silicone-composite.

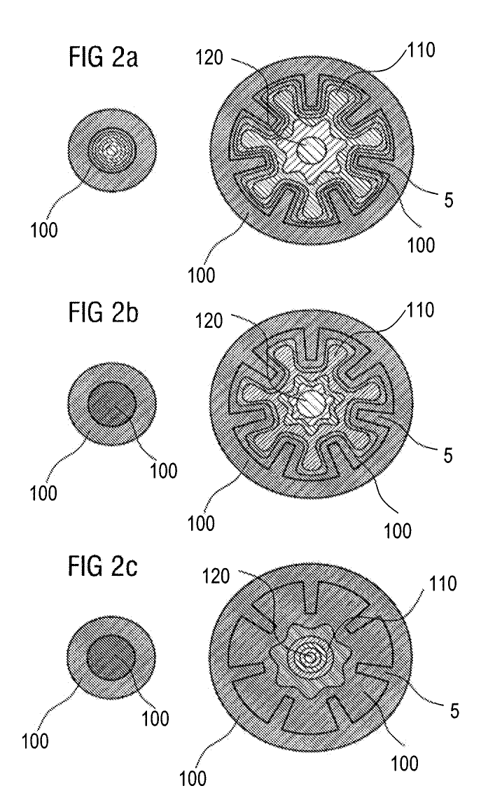

FIGS. 2a to 2c show the preheating process of a liquid in an embodiment of a mold according to FIG. 1. Three cross sections of the middle of the subsection 20 (left) and the middle of the subsection 10 (right) are shown. The subsection 20 has a constant outer diameter of 2.5 mm and a constant inner diameter of 1 mm. The subsection 10 has a constant outer diameter of 6 mm and a constant inner diameter of 4.5 mm without the ribs.

The preheating process starts with a liquid at a temperature of −40° C., and a temperature of the mold 1 of 105° C. (100). FIG. 2a shows the preheating process after 2 seconds, FIG. 2b after 5 seconds, and FIG. 2c after 10 seconds. Already after 2 seconds (FIG. 2a), the liquid between the ribs (5) has a temperature of minimum 500C (110). The temperature of the liquid in the centre of the middle of the subsection 10 is still at −35° C. (120). After 5 seconds (FIG. 2b), the fluid in the centre of the middle of the subsection 20 has approximately reached the temperature of the mold itself, 105° C. (100). After 10 seconds (FIG. 2c), the fluid between the ribs (5) in the middle of the subsection 10 has also reached the temperature of 105° C. (100).

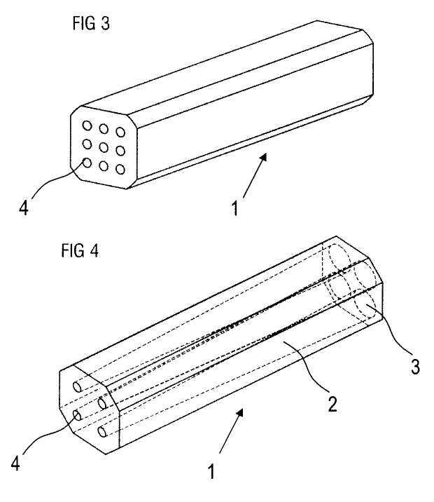

FIG. 3 shows a further embodiment comprising more than one fluid inlet 3 and more than one fluid outlet 4. The mold has a non cylindrical form and nine fluid inlets 3 and nine fluid outlets 4. The advantage of an embodiment form like this is that a large volume of fluid can be heated in a small device. This embodiment could be used for truck engines which high fuel consumption.

FIG. 4 schematically shows the view inside a non-cylindrically formed mold with a plurality of fluid channels 2, in particular with four fluid channels. Here the fluid channels 2 narrows over the entire length of the mold 1.

The mold 1 can be used for example in an arrangement with a nozzle. Such an arrangement can be used to preheat fuel in combusting engines. The preheated fuel assures a good spray effect in a few seconds because of its heating efficiency despite the fuel having a low temperature before it entering the preheating system. Thus, such an arrangement is in particular useful for the cold start of an engine using ethanol or methanol as fuel. Arranging the mold 1 close to the nozzle ensures that the fluid reaches the spraying end of the nozzle at the desired temperature. In the case of ethanol, this temperature has to be above 13° C. to obtain a satisfying spray result. In some cases the spray result could be improved if the fluid reaches the nozzle with a rotation around the axis of the flow. So the inner surface of the mold 1 can be formed in a manner such that the fluid is made to rotate like this.

The mold 1 may include an element of an arrangement further comprising a valve and a nozzle. The fuel is preheated by the mold 1 before it is dosed by the valve into the nozzle out of which the fuel is then sprayed.

Other implementations are within the scope of the following claims. Elements of different implementations, including elements from applications incorporated herein by reference, may be combined to form implementations not specifically described herein.

What is claimed is:

1. A mold comprising:
a fluid channel;
a fluid inlet;
a fluid outlet;
the mold comprising a PTC-ceramic;
wherein, upon application of a voltage, the mold is heated such that a fluid passing through the fluid channel can be heated.

2. The mold according to claim 1, wherein the fluid inlet is larger than the fluid outlet.

3. The mold according to claim 1, wherein the fluid channel comprises a first subsection and a second subsection; and
wherein a cross section of the first subsection is larger than a cross section of the second subsection.

4. The mold according to claim 3, wherein an inner surface of the mold in a first subsection of the fluid channel is enlarged via geometric protrusions.

5. The mold according to claim 4, wherein each protrusion comprises a laminar form.

6. The mold according to claim 5, wherein the protrusions comprise ribs.

7. The mold according to claim 6, wherein the ribs are helical.

8. The mold according to claim 1, wherein an inner surface of the mold is formed in a manner such that fluid flowing through the fluid channel rotates around an axis along which the fluid flows.

9. The mold according to claim 1, wherein the mold comprises a plurality of fluid outlets.

10. The mold according to claim 1, wherein the fluid is a liquid.

11. The mold according to claim 10, wherein a composition of the PTC-ceramic is based on a boiling point of the liquid.

12. The mold according to claim 10, wherein the liquid comprises ethanol as a main component.

13. The mold according to claim 1, wherein the PTC-ceramic comprises BaTiO₃ as a main component.

14. The mold according to claim 13, wherein the BaTiO₃ is doped in a manner such that a resistance of the PTC-ceramic reaches a level at which electric current through the PTC-ceramic is reduced to prevent further heating of the PTC-ceramic.

15. The mold according to claim 1,
wherein a composition of the PTC-ceramic is:
ABO₃+SiO₂,
wherein A is one or more of Ba, Ca, Sr, Y, and Pb; and
wherein B is one or more of Ti and Mn; and
wherein a part of Si is 0.5 to 4.5 mol percent of a sum of both components.

16. The mold according to claim 15, wherein A comprises the following parts in mol percent: Ba 80%-85%, Ca 10%-15%, Sr 1%-5%, Y 0.1%-1%, and
wherein B comprises the following parts in mol percent: Ti 99.8-99.99%, Mn 0.01%-0.2%.

17. The mold according to claim 1, wherein a concentration of any metallic impurity is lower than 10 ppm of the PTC-ceramic.

18. The mold according to claim 1, wherein the mold is injection molded.

19. The mold according to claim 1, wherein the mold comprises an electrically conductive layer on an inner surface of the mold and on an outer surface of the mold.

20. The mold according to claim 1, wherein an inner surface of the mold comprises a passivation layer.

21. The mold according to claim 10, wherein the fluid is a fuel.

22. The mold according to claim 21, wherein the fuel comprises ethanol as a main component.

23. An arrangement comprising
a mold according to claim 1; and
a nozzle;
whereby fluid first passes through the mold and is then ejected by the nozzle.

24. The arrangement according to claim 23, further comprising a valve is arranged between the nozzle and the mold.
